(19) United States
(12) Patent Application Publication
(10) Pub. No.: US 2026/0326516 A1
(43) Pub. Date: Oct. 22, 2026

(54) SUN VISOR EXTENDER AND VEHICLE

(71) Applicant: Shenzhen Glamortech Industrial Co., Ltd, Shenzhen (CN)

(72) Inventor: PENGBO MU, Huizhou (CN)

(21) Appl. No.: 19/700,219

(22) Filed: Jun. 6, 2026

(30) Foreign Application Priority Data
Mar. 11, 2026 (CN) 202620302361.X

(51) Int. Cl. B60J 3/02

(52) U.S. Cl. CPC B60J 3/0208

(57) ABSTRACT

A sun visor extender and a vehicle are provided, and relate to the field of in-vehicle equipment accessories, to solve the problem that an existing sun visor extender cannot adapt to sun visors with different sizes. The sun visor extender includes: an extender body and a plurality of fixing assemblies configured to fix the extender body to a sun visor. The plurality of fixing assemblies are spaced apart from each other and arranged on the extender body. Each fixing assembly is slidably connected to the extender body. By slidably arranging the plurality of fixing assemblies on the extender body, the problem of compatibility of sun visors for different vehicle models is solved; the extender body can also be prevented from blocking a makeup mirror; and an application range of a product is expanded.

### TECHNICAL FIELD

The present disclosure relates to the technical field of in-vehicle equipment accessories, and in particular, to a sun visor extender and a vehicle.

### BACKGROUND

With the rapid development and popularization of the automobile industry, automobiles have become mainstream travel tools for people, and their ownership continues to rise. In a daily driving process, a driver is often confronted with various complex light interferences. For example, the low-angle morning sunlight directly shines into the eyes of the driver at dawn; backlight in the evening makes it difficult to distinguish road conditions ahead; and slippery roads after rain or snow strongly reflect the sunlight or vehicle light. These light interferences not only cause visual discomfort and fatigue to the driver, but also temporarily impair the ability of the driver to observe and judge road conditions, thereby posing potential safety hazards.

To address the foregoing issues, vehicles are generally equipped with built-in sun visors at front parts of tops of cabs. However, a factory-fitted sun visor has a relatively single function and is usually only able to perform simple angular rotation. A sun shading area and coverage range of the sun visor are fixed, so that the sun visor cannot flexibly and effectively block diversified glare coming from a lateral front side or a lateral side of a vehicle or reflected by roads. Therefore, the sun shading effect of the sun visor is limited in many practical driving scenarios.

In terms of this unmet core requirement, various automobile sun visor extender products have emerged on the market, to aim at expanding a sun shading region of the factory-fitted sun visor through additional devices. However, the existing extender products have a significant technical bottleneck in the mounting universality and the adaptability. It is particularly prominent that many extenders are mounted by using fixing straps or similar fixing structures, but distances between these fixing structures are preset and cannot be adjusted. The factory-fitted sun visors of vehicles of different vehicle models, and even vehicles of the same brand but different vehicle models, have different sizes, especially the sizes and positions of the makeup mirrors embedded into the sun visors have significant differences. The fixing structures with the fixed distances cannot adapt to this diversity. As a result, the fixing structures cannot be firmly mounted on sun visors for particular vehicle models, or the fixing structures will block or press the makeup mirrors and affect normal use of the makeup mirrors. This seriously limits the universality and the user experience of a product.

### SUMMARY

A main objective of the present disclosure is to provide a sun visor extender and a vehicle, to solve the problem that an existing sun visor extender cannot adapt to sun visors with different sizes.

To solve the above technical problems, the present disclosure adopts the following technical solutions:
A sun visor extender includes:
an extender body; and
a fixing assembly configured to fix the extender body to a sun visor.

A plurality of fixing assemblies are included, which are spaced apart and arranged on the extender body. Each fixing assembly is slidably connected to the extender body.

Further, each fixing assembly includes a first fixing member and a second fixing member. The first fixing member and the second fixing member are respectively slidably connected to the extender body. The first fixing member and the second fixing member are detachably connected to each other.

Further, a length of the first fixing member and/or a length of the second fixing member are/is adjustable.

Further, the extender body includes a first main body and a sun shading member. The sun shading member is slidably connected to the first main body.

Further, the extender body further includes a second main body, and the second main body and the first main body enclose to form a receiving cavity with an opening. The receiving cavity is configured to receive the sun shading member.

Further, the extender body includes a first connector and a second connector. The first connector is slidably connected to the first main body. The first connector is configured to connect the first main body with the second connector. The second connector is also connected to the sun shading member. The sun shading member rotates through the second connector.

Further, two first limiting portions are spaced apart and arranged on the first main body. The first limiting portions are distributed on left and right sides of the first connector to limit lateral displacement of the first connector.

Further, a distance between the two first limiting portions is less than a lateral size of the first connector.

Further, two second limiting portions are spaced apart and arranged on the first main body. The second limiting portions are distributed on upper and lower sides of the first connector to limit lateral displacement of the first connector.

Another aspect further provides a vehicle, including a cab. A sun visor is arranged inside the cab. The sun visor extender as described above is further included. The sun visor extender is arranged on the sun visor.

The present disclosure has the following beneficial effects: By slidably arranging the fixing assemblies on the extender body, the problem of compatibility of sun visors for different vehicle models is solved; the extender body can also be prevented from blocking a makeup mirror; and an application range of a product is expanded.

### BRIEF DESCRIPTION OF THE DRAWINGS

To describe the technical solutions in the embodiments of the present disclosure or in the prior art more clearly, the following briefly introduces the accompanying drawings for describing the embodiments or the related art. Apparently, the accompanying drawings in the following description show merely some embodiments of the present disclosure, and a person of ordinary skill in the art may still derive other drawings according to structures shown in these accompanying drawings without creative efforts.

FIG. 1 is a schematic diagram of a structure of a sun visor extender according to the present disclosure;

FIG. 2 is a schematic exploded diagram of a sun visor extender according to the present disclosure;

FIG. 3 is a schematic enlarged diagram of part A in FIG. 2 of the present disclosure;

FIG. 4 is a schematic diagram of a structure of a sun visor extender with a second main body omitted according to the present disclosure;

FIG. 5 is a schematic diagram of a structure of fixing assemblies and a first main body of a sun visor extender according to the present disclosure;

FIG. 6 is a schematic diagram of a structure of a first connector, a second connector, and a sun visor according to the present disclosure;

FIG. 7 is a schematic diagram of a structure of a second fixing member and a guide shaft mounting seat according to the present disclosure; and

FIG. 8 is a schematic diagram of a structure of a first main body and a first fixing member according to the present disclosure.

Where,

1: extender body; 11: first main body; 112: first limiting portion; 113: second limiting portion; 114: insertion slot; 12: sun shading member; 13: second main body; 14: first connector; 15: second connector; 16: guide portion; 17: movable portion; 2: fixing assembly; 21: first fixing member; 22: second fixing member; 23: guide shaft mounting seat; and 231: first protrusion.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

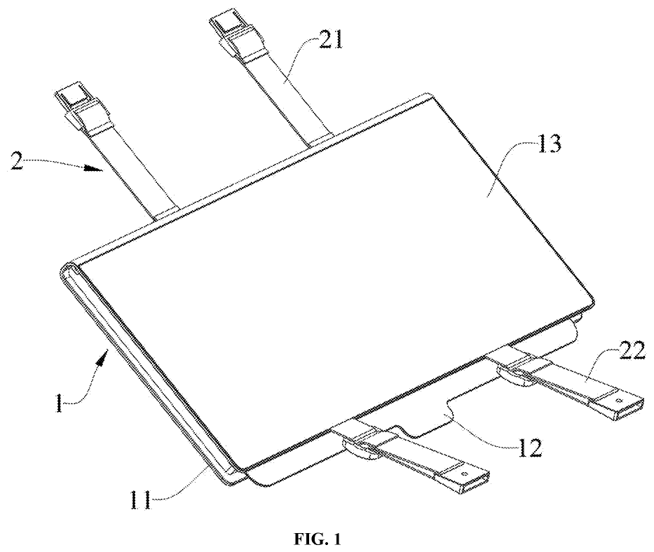

Referring to FIG. 1, a sun visor extender in an embodiment of the present disclosure is designed to adapt to sun visors with different sizes to ensure the safety of driving of a sedan, an off-road vehicle, an excavator, or other vehicles that can be used for carrying passengers and are provided with sun visors.

Referring to FIG. 1, the sun visor extender includes an extender body 1, a fixing assembly 2, and a connection assembly. The extender body 1 can be of a roughly elongated plate-like structure to adapt to a common sun visor shape. At least one fixing assembly 2 is provided. To enhance the strength and uniformity of a force, a plurality of fixing assemblies, such as two or three fixing assemblies, can be provided. The plurality of fixing assemblies 2 are spaced apart and arranged on the extender body 1, to ensure that the extender body 1 can be fixed to a sun visor. The connection assembly is configured to flexibly connect the fixing assembly 2 to the extender body 1, so as to flexibly adjust the different positions of the fixing assembly 2 relative to the extender body 1 based on the size of the sun visor and a position of a makeup mirror arranged on the sun visor, thereby ensuring that the extender body 1 can be fixed to the sun visor without affecting the use of the makeup mirror. This can cause the sun visor extender to adapt to the vast majority of vehicles of different brands and models on the market, and greatly enhances the universality of a product and the convenience of mounting by a user.

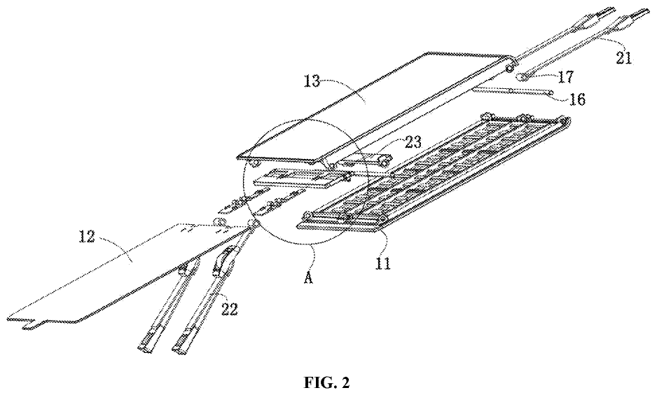

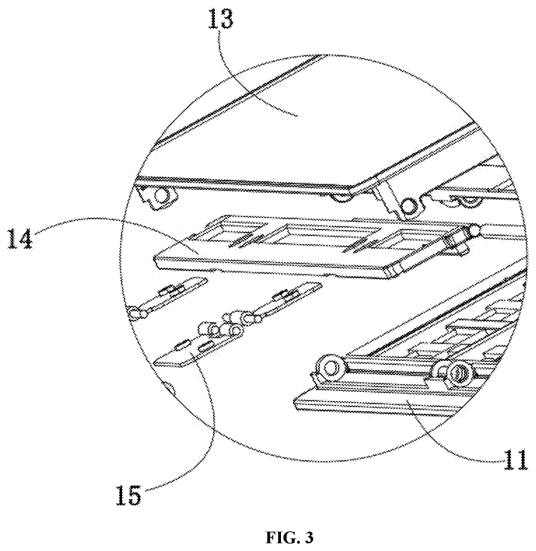

Referring to FIG. 1 to FIG. 5, each fixing assembly 2 may include a first fixing member 21 and a second fixing member 22. The first fixing member 21 and the second fixing member 22 are respectively slidably connected to the extender body 1. The first fixing member 21 and the second fixing member 22 are detachably connected to each other.

The connection assembly includes a guide portion 16 arranged on the extender body 1, and a movable portion 17 arranged on the first fixing member and the second fixing member. The movable portion is in slidable fit with the guide portion.

Specifically, in one implementation, the guide portion 16 adopts a guide shaft. Guide shafts can be respectively arranged at upper and lower ends of the extender body 1. The movable portion 17 adopts a hole. A hole is formed in a first end of the first fixing member 21. The guide shaft at the upper end of the extender body 1 is inserted into the hole, thereby achieving slidable connection between the first fixing member 21 and the guide shaft. A hole can also be formed in a first end of the second fixing member 22. The guide shaft at the lower end of the extender body 1 can be inserted into the hole to achieve slidable connection between the second fixing member 22 and the guide shaft.

In another implementation, the guide portion 16 adopts a sliding chute. Upper and lower ends of the extender body 1 can be respectively provided with sliding chutes. The movable portion 17 adopts a sliding block. A first end of the first fixing member 21 and a first end of the second fixing member 22 are respectively provided with sliding blocks. By the cooperation between the sliding chutes and the sliding blocks, the first fixing member 21 and the second fixing member 22 are slidably connected to the extender body 1.

A second end of the first fixing member 21 and a second end of the second fixing member 22 can be detachably connected to each other through hook and loop fasteners, in a fastening manner, or the like.

A length of the first fixing member 21 and/or a length of the second fixing member 22 are/is adjustable. Specifically, the first fixing member 21 and the second fixing member 22 can be elastic bands. During fixing, the elastic bands can be stretched to fix the extender body 1 to the sun visor. The first fixing member 21 and the second fixing member 22 can also be webbings with three-bar buckles, and effective lengths of the first fixing member 21 and the second fixing member 22 can be adjusted through the three-bar buckles. Certainly, the first fixing member 21 and the second fixing member 22 can also be in other length adjustable forms. This embodiment does not limit this. By setting the lengths of the first fixing member 21 and the second fixing member 22 to be adjustable, the extender body 1 is prevented from being loosened or shaking during operation of a vehicle, thereby enhancing the safety and reliability of use.

Referring to FIG. 1 to FIG. 8, in one embodiment, the extender body 1 includes a first main body 11 and a sun shading member 12. The sun shading member 12 can be slidably connected to the first main body 11 through a sliding chute, a guide rail, a guide rod, or the like. In case of strong lateral sunlight or road reflected light, a user can drive the sun shading member 12 to slide on the first main body 11, so as to move the sun shading member 12 from a storage position to an unfolding position, so that the sun shading member 12 extends laterally from an original sun visor, thereby effectively enlarging a sun shading region and blocking interference light that would otherwise leak into the field of view of a driver. When not in use, the sun shading member 12 can be stored to keep an interior of the vehicle clean and beautiful, thereby avoiding the impact on the lateral vision of the driver.

The extender body 1 further includes a second main body 13. The second main body 13 and the first main body 11 enclose to form a receiving cavity with an opening. The receiving cavity is configured to receive the sun shading member 12. The opening of the receiving cavity can be provided in a left, right, or lower side of the sun visor for easy use by a passenger in a driver seat or a front passenger seat of the vehicle. Outer side surfaces of the first main body 11 and the second main body 13 can also be provided with covers. The covers can be made of a genuine leather or imitation leather material, and can also be patterned to enhance the aesthetic degree of the sun visor extender.

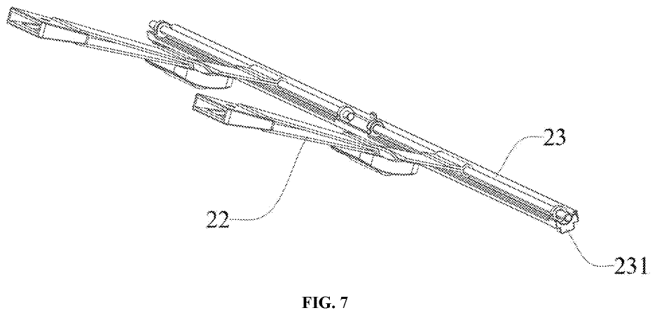

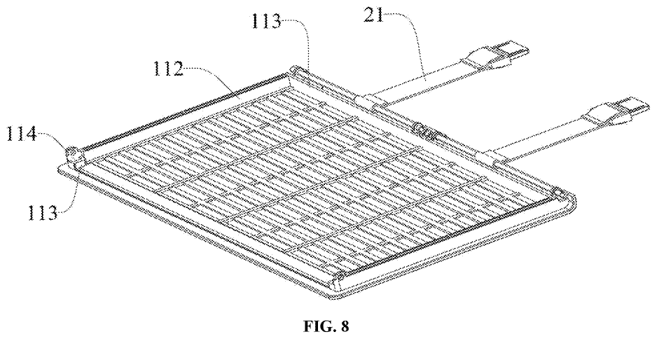

Referring to FIG. 7 and FIG. 8, the first main body 11 can be provided with an insertion slot 114 on each of two sides corresponding to the opening of the receiving cavity. A guide shaft mounting seat 23 for slidably connecting the second fixing member 22 to the extender body 1 can be provided with a first protrusion 231 for insertion into the insertion slot 114, and the first protrusion 231 is interference fit with the insertion slot 114. By the arrangement of the guide shaft mounting seat 23 and the provision of the first protrusion 231 on the guide shaft mounting seat 23 and the insertion slot 114 on the first main body 11, it is convenient to process the opening of the receiving cavity corresponding to the first main body 11, so as to reduce the manufacturing costs.

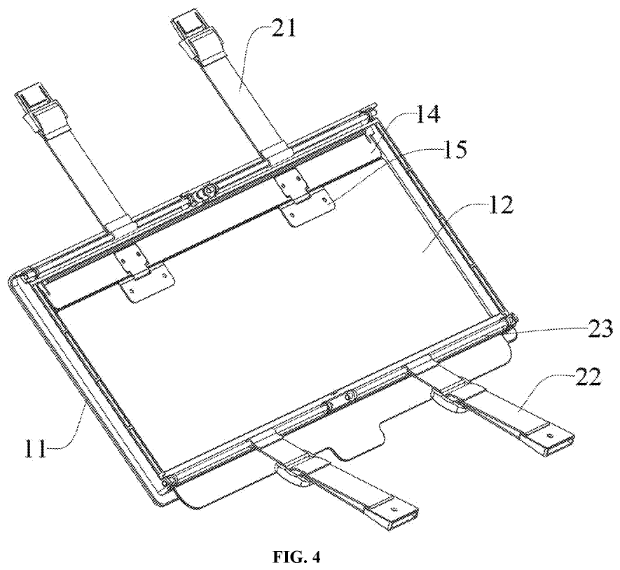

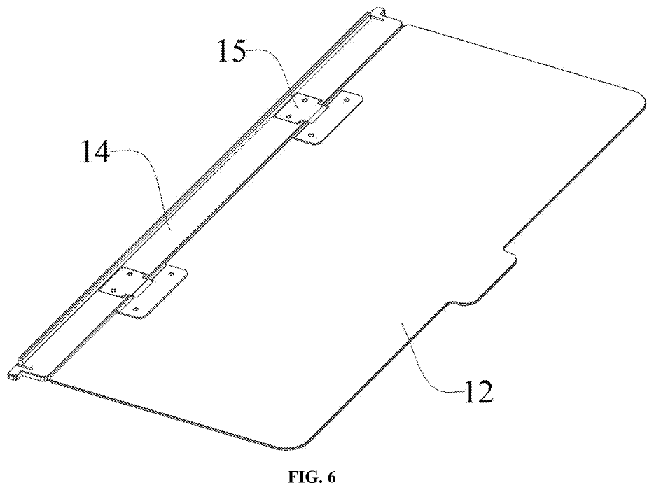

Referring to FIG. 4 and FIG. 6, the extender body 1 may further include a first connector 14 and a second connector 15. The first connector 14 and the first main body 11 can be slidably connected to each other through a guide rail, a guide shaft, or in another manner. The first connector 14 is configured to connect the first main body 11 to the second connector 15, and the second connector 15 is also connected to the sun shading member 12. The second connector 15 can be a hinged structure such as a hinge, so that the sun shading member 12 can rotate through the second connector 15, thereby blocking light incident into a cab from different angles.

In this embodiment, the sun shading member 12 is a mirror piece. A mirror surface of the mirror piece faces a user, which can also replace the function of a makeup mirror, making it convenient for use by people of different heights.

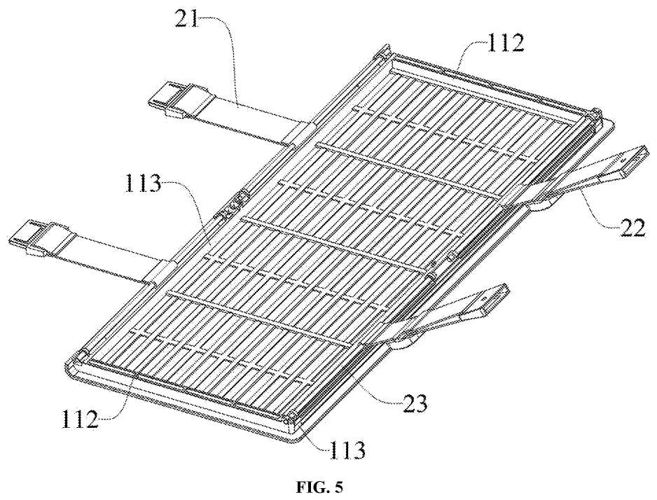

Referring to FIG. 4, FIG. 5, and FIG. 8, two first limiting portions 112 are spaced apart and arranged on the first main body 11. The first limiting portions 112 can be convex strip-shaped structures arranged on the first main body 11. The first limiting portions 112 are spaced apart and arranged on left and right sides of the first connector 14, to for, between the two first limiting portions 112, a sliding chute for allowing the first connector 14, and the two first limiting portions 112 can also limit lateral displacement of the first connector 14.

A distance between the two first limiting portions 112 can be less than a lateral size of the first connector 14, that is, the sliding chute formed between the two first limiting portions 112 forms interference fit with the first connector 14 to overcome the gravities of the first connector 14, the second connector 15 arranged on the first connector 14, and the sun shading member 12, thereby ensuring that the sun shading member 12 can be maintained in a current position during use.

Two second limiting portions 113 are further spaced apart and arranged on the first main body 11. The second limiting portions 113 are distributed on upper and lower sides of the first connector 14 to limit lateral displacement of the first connector 14. The second limiting portion 113 arranged on the upper side of the first connector 14 can be a convex strip-shaped structure. The second limiting portion 113 arranged on the lower side of the first connector 14 includes two second protrusions which are spaced apart and arranged on the first main body 11, and a distance between them is less than the distance between the two first limiting portions 112, but greater than a lateral size of the sun shading member 12. The left and right sides of the first connector 14 are respectively L-shaped structures. Inner side of the L-shaped structures are respectively configured to abut against side surfaces of corresponding second protrusions, thereby preventing the first connector 14 from being detached from the receiving cavity.

Another aspect further provides a vehicle, including a cab in which a sun visor is provided, and the sun visor extender as described above. The extender body 1 is arranged on the sun visor through a fixing assembly 2. The vehicle and the sun visor are the existing technologies, so that this embodiment will not elaborate them.

It should be noted that the descriptions of the terms “first”, “second”, and the like in the present disclosure are used for descriptive purposes only and are not to be construed as indicating or implying relative importance or to implicitly indicate the number of technical features indicated. Therefore, features defining “first” and “second” can explicitly or implicitly include at least one of the features. In addition, the term “and/or” used throughout the text covers three technical solutions. A and/or B is used as an example, including: a technical solution of A, a technical solution of B, and a technical solution in which A and B are simultaneously satisfied. In addition, the technical solutions between the various embodiments can be combined with each other, but need to be implemented by those of ordinary skill in the art. When there is a conflict in a combination of technical solutions or the combination cannot be achieved, it should be considered that the combination of the technical solutions does not exist and does not fall within the protection scope of the present disclosure.

The above describes only preferable embodiments of the present disclosure and does not limit the patent scope of the present disclosure. Any equivalent structural transformations made using the specification and accompanying drawings of the present disclosure within the inventive concept of the present disclosure, or directly or indirectly applied in other related technical fields, all fall within the scope of patent protection of the present disclosure.

What is claimed is:

1. A sun visor extender, comprising:
an extender body;
a fixing assembly configured to fix the extender body to a sun visor; and
a connection assembly configured to movably connect the fixing assembly to the extender body, to cause the fixing assembly to be connected to different positions of the extender body.

2. The sun visor extender according to claim 1, wherein the fixing assembly comprises a first fixing member and a second fixing member; the first fixing member and the second fixing member are respectively slidably connected to the extender body; and the first fixing member and the second fixing member are detachably connected to each other.

3. The sun visor extender according to claim 2, wherein the connection assembly comprises a guide portion arranged on the extender body, and a movable portion arranged on the first fixing member and the second fixing member; the movable portion is in slidable fit with the guide portion; and
a length of the first fixing member and/or a length of the second fixing member are/is adjustable.

4. The sun visor extender according to claim 1, wherein the extender body comprises a first main body and a sun shading member, and the sun shading member is slidably connected to the first main body.

5. The sun visor extender according to claim 4, wherein the extender body further comprises a second main body, and the second main body and the first main body enclose to form a receiving cavity with an opening; and the receiving cavity is configured to receive the sun shading member.

6. The sun visor extender according to claim 5, wherein the extender body further comprises a first connector and a second connector; the first connector is slidably connected to the first main body; the first connector is configured to connect the first main body with the second connector; the second connector is also connected to the sun shading member; and the sun shading member rotates through the second connector.

7. The sun visor extender according to claim 6, wherein two first limiting portions are spaced apart and arranged on the first main body; and the first limiting portions are distributed on left and right sides of the first connector to limit lateral displacement of the first connector.

8. The sun visor extender according to claim 7, wherein a distance between the two first limiting portions is less than a lateral size of the first connector.

9. The sun visor extender according to claim 7, wherein two second limiting portions are spaced apart and arranged on the first main body; and the second limiting portions are distributed on upper and lower sides of the first connector to limit lateral displacement of the first connector.

10. A vehicle, comprising a cab, wherein a sun visor is arranged inside the cab; the sun visor extender according to claim 1 is further comprised; and the sun visor extender is arranged on the sun visor.
